(19) United States
(12) Patent Application Publication
(10) Pub. No.: US 2004/0046986 A1
(43) Pub. Date: Mar. 11, 2004

(54) End-of-printing monitor system and method of monitoring end-of-printing

(75) Inventors: Tomoaki Kuwabara, Nagano-ken (JP); Koji Akiyoshi, Nagano-ken (JP)

Correspondence Address: SUGHRUE MION, PLLC, 2100 PENNSYLVANIA AVENUE, N.W., WASHINGTON, DC, 20037, US

(73) Assignee: SEIKO EPSON CORPORATION

(21) Appl. No.: 10/463,871

(22) Filed: Jun. 18, 2003

(30) Foreign Application Priority Data
Jun. 18, 2002 (JP) 2002-176953(P)

(51) Int. Cl. B41F 1/00; G06F 15/00

(52) U.S. Cl. 358/1.14; 358/1.15

(57) ABSTRACT

A printing system of the present invention monitors end-of-printing of each output print job, based on the status of a printer and the presence of any remaining data in a spooler. In the printing system of the present invention, a monitor system 31 receives a print job and causes a printer 32 locally connected with the monitor system 31 to carry out printing. In the monitor system 31, a job control module 201 acquires one print job from a job buffer 202 and transmits the print job to a spooler 206. The spooler 206 then transfers the print job to the printer 32 to start printing. After the start of printing, an end-of-printing decision module 205 checks the presence of any remaining data in the spooler 206 and acquires the status of the printer 32 from a printer management module 204. When no remaining data is present in the spooler 206 and the acquired status of the printer 32 represents ‘ready’ or ‘standby for printing’, the end-of-printing decision module 205 determines that the printer 32 has completed printing of the print job.

### BACKGROUND OF THE INVENTION

1. Field of the Invention

The present invention relates to a technique of monitoring end-of-printing in a printing apparatus.

2. Description of the Related Art

Various printers are used as one type of output device of the computer. The printer often has one-to-one connection with the computer (hereafter referred to as ‘local connection’) and receives data from the computer to carry out printing. In another application, the printer is connected to a LAN (local area network) and is shared by multiple computers connecting with the LAN.

The use of a protocol called IPP (Internet Printing Protocol) enables a client to be connected to the Internet and to use a printing apparatus of a known URI (Uniform Resource Indicator) for printing. The applicant of the present invention has proposed a system that uses an intermediation server to mediate a print job and thereby use a printing apparatus of an unknown URI for printing (for example, the technique disclosed in JP2001-236183A).

All of above-mentioned techniques follow the procedure of: (a) transmitting a print job to a spooler corresponding to a printer; and (b) transferring the print job from the spooler to the printer. The spooler determines end-of-printing at the time of a start of transfer of the print job and notifies a print job transmission source of the end-of-printing.

Since these prior art techniques determine the end-of-printing at the time of a start of transfer of the print job from the spooler to the printer, the determination of the end-of-printing is accordingly made, even when some print data is still left in the spooler. The user can thus not accurately confirm that the output print data has been printed successfully. For example, wrong determination of the end-of-printing may be made, when an error arises in the printer after the start of transfer of the print job from the spooler to the printer.

In the case of printing via the Internet, for example, in the system using the print intermediation server, the user who outputs a print job may not accurately check whether or not printing has been completed normally. Such wrong determination worsens the convenience and the reliability of the printing system.

### SUMMARY OF THE INVENTION

The object of the present invention is thus to provide a technique of accurately determining end-of-printing in a printing apparatus.

In order to attain at least part of the above and the other related objects, the present invention is directed to a monitor apparatus that monitors a printing apparatus. The monitor apparatus includes: a status acquisition module that acquires an operating state of the printing apparatus; a data check module that checks presence or absence of any print data in a spooler corresponding to the printing apparatus; a job control module that outputs print data to the spooler; and a decision module that determines end-of-printing of the output print data, based on information regarding the operating state of the printing apparatus acquired by the status acquisition module and regarding the presence or the absence of any print data in the spooler checked by the data check module.

Here the operating state of the printing apparatus may be a status of the printing apparatus, for example, ‘ready’ (standby for printing), ‘busy’ (in use), or ‘error’.

The end-of-printing of the print data is determined, based on the combination of the information obtained by the status acquisition module with the information obtained by the data check module. This arrangement effectively raises the accuracy of determination of the end-of-printing by following reason. The determination based on only the operating state has some difficulties; the status ‘busy (in use)’ is set in only a very short time and may make not be acquired successfully, while the status ‘ready (standby for printing)’ does not specify the current state of the print data as ‘before printing’ or ‘after printing’. The determination based on only the presence or the absence of print data in the spooler also has some difficulties; the absence of print data in the spooler checked by the data check module does not discriminate the data absence in the course of transfer of the print data by the job control module from the data absence due to completion of all the printing.

The monitor apparatus of the present invention, on the other hand, uses both the operating state and the presence or absence of print data in the spooler and enables the user to confirm successful printing of the output print data, thus enhancing the convenience of the printing apparatus.

In one preferable application of the monitor apparatus of the invention, the decision module determines end-of-printing, when there is no print data in the spooler and the operating state of the printing apparatus acquired by the status acquisition module represents standby for printing.

When no print data is present in the spooler, the ‘standby for printing’ state acquired by the status acquisition module is specified as ‘after printing’. This arrangement ensures accurate determination of end-of-printing of the print data and thus enhances the convenience of the printing apparatus.

In another preferable application of the monitor apparatus of the invention, the job control module forbids output of next print data until the decision module determines end-of-printing of currently output print data.

Next print data is not accumulated in the spooler, until determination of the end-of-printing of the currently output print data. This arrangement desirably enhances the accuracy of determination of the end-of-printing.

In still another preferable application of the monitor apparatus of the invention, the print data has a predetermined format that allows for output by the unit of a page, the job control module outputs the print data by the unit of a page, and the decision module determines a printing result of the print data by the unit of a page.

The predetermined format is, for example, PDF. The printing result may represent successful printing or failed printing of each page and may further include detailed information, such as the number of printed pages and the number of failed pages.

This arrangement allows for detailed management of the printing result by the unit of a page, thus ensuring accurate determination of the end-of-printing.

The monitor apparatus of the present invention may cause the printing apparatus to carry out reprinting from a first failed page, based on the printing result managed by the unit of a page. This arrangement ensures successful printing without output of the print data all over again, thus enhancing the user's convenience.

In one preferable embodiment of the present invention, the monitor apparatus and the printing apparatus, as well as a job output apparatus that outputs a print job to the printing apparatus, is connected with a network. The monitor apparatus may further have a result notification module that notifies the job output apparatus of a decision result regarding end-of-printing of the output print job at a preset timing.

The job output apparatus may be, for example, a computer, a cell phone, or a personal digital assistant (PDA), and is capable of outputting print jobs to the printing apparatus via the network.

The preset timing may be after the decision module determines the end-of-printing of the whole print job or after the decision module determines the end-of-printing of each page. In the case where an output instruction of multiple print jobs is given to the job output apparatus, the preset timing may be after the determination of the end-of-printing of all the multiple print jobs.

The preset timing may be selected by the user, when the user gives a printing instruction of a print job through operations of another device separate from the job output apparatus. Here another device may be a computer, and the method of selection may open a window for selecting the timing of notification on a display of the computer.

The decision result of the end-of-printing includes information regarding failed printing, and successfully printed pages, in addition to normal termination of printing. The result notification module notifies the decision result in the form of a message on a display of the job output apparatus or in a combination of various media like voices, music, and images.

This arrangement enables the job output apparatus to check the printing result of the output print job. After confirmation of the end-of-printing, the monitor apparatus may delete the print data that has been printed and is no more required. The failed print data may be subject to reprinting from a first failed page.

The present invention is not restricted to the monitor apparatus discussed above, but may be constructed as a corresponding monitor method that monitors the printing apparatus. The invention may also be actualized by a computer program that attains the monitor method, a recording medium in which such a computer program is recorded, a data signal that includes such a computer program and is embodied in a carrier wave, and a variety of other suitable applications. The additional factors discussed above with regard to the monitor apparatus may also be adopted in the respective applications.

When the technique of the present invention is actualized as either the computer program or the recording medium in which the computer program is recorded, the construction may include the whole program for actuating the monitor apparatus or only a specific part of the program that attains the characteristic functions of the present invention. Typical examples of the recording medium include flexible disks, CD-ROMs, DVD-ROMs, magneto-optic discs, IC cards, ROM cartridges, punched cards, prints with barcodes or other codes printed thereon, internal storage devices (memories like RAMs and ROMs) and external storage devices of computers, and a diversity of other computer readable media.

These and other objects, features, aspects, and advantages of the present invention will become more apparent from the following detailed description of the preferred embodiments with the accompanying drawings.

### BRIEF DESCRIPTION OF THE DRAWINGS

FIG. 1 a schematic that illustrates the construction of a printing system in a first embodiment of the invention;

FIG. 2 is a flowchart showing an output process routine executed in the first embodiment;

FIG. 3 is a schematic that illustrates the internal structure of a monitor system included in the printing system of FIG. 1;

FIG. 4 is a flowchart showing an end-of-printing monitor routine executed in the first embodiment;

FIG. 5 is a flowchart showing an end-of-printing monitor routine executed in a second embodiment of the invention;

FIG. 6 is a flowchart showing a reprinting routine executed in a third embodiment of the present invention;

FIG. 7 is a flowchart showing a reprinting routine executed in a fourth embodiment of the present invention;

FIG. 8 is a schematic that shows a reprinting guide window opened in the fourth embodiment; and

FIG. 9 is a schematic that shows an end-of-printing monitor system in one modified example.

### DESCRIPTION OF THE PREFERRED EMBODIMENTS

Some modes to carry out the invention are discussed below as preferred embodiments in the following sequence:

A. First Embodiment

A1. Outline of System

A2. Output Process

A3. Internal Structure of Agent

A4. End-of-Printing Monitor Process

B. Second Embodiment

B1. End-of-Printing Monitor Process

C. Third Embodiment

C1. Re-Printing Process

D. Fourth Embodiment

D1. Re-Printing Process

D2. Re-Printing Guide Window

E. Modifications

A. First Embodiment

A1. Outline of System

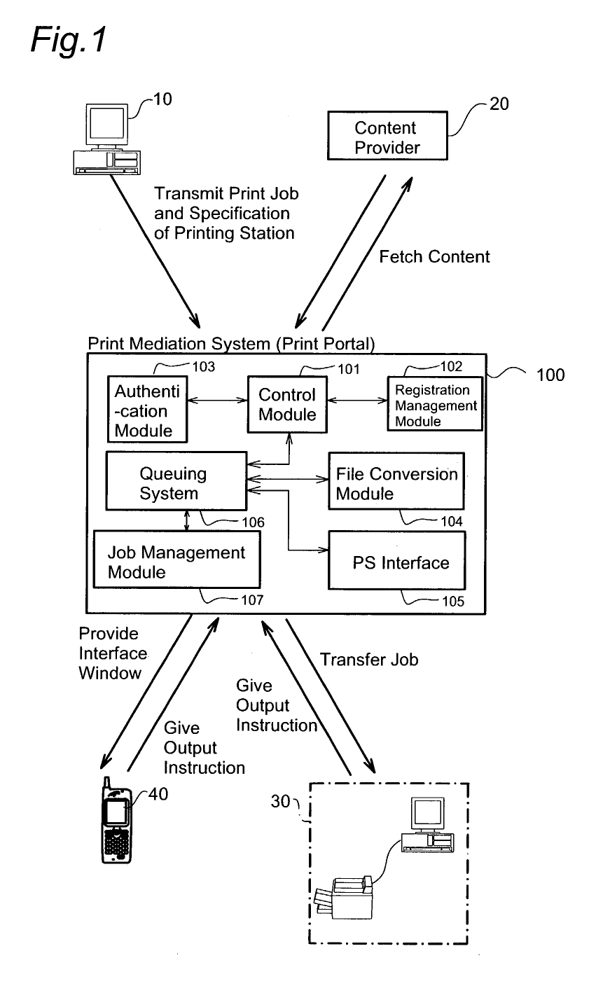

FIG. 1 schematically illustrates the construction of a printing system in a first embodiment of the present invention. This printing system has a print mediation system 100 as its center and a large number of clients connecting with the print mediation system 100 via a network to actualize printing operations via the network. The print mediation system (hereafter referred to as print portal) 100 receives and manages print jobs transmitted from a print job transmission source 10. In response to an output instruction transmitted from one instruction client 40 of a cell phone, the print portal 100 transmits a selected print job to a specified printing station 30. The printing station 30 receives the transmitted print job and carries out actual printing of the received print job. There are a large number of the printing stations 30 located in houses, offices, and firms. Each user selects an optimum output destination among the printing stations 30.

The Internet is applied for the network in the structure of this embodiment, although the network may be a more restricted network like a LAN or a computer online network. In the following description, it is assumed that the network is the Internet.

The print job transmission source 10 is, for example, a general purpose computer having functions of access to the network. The object to be printed may be any of images and documents created by the print job transmission source 10 according to diverse application programs, e-mails, and Web pages provided by various content providers 20 on the Internet. In the case of printing a Web page, a content created in HTML or another language may be transmitted as a print job, or alternatively a URL (uniform resource locator) of the Web page may be transmitted as a print job. In the latter case, the print portal 100 may fetch a content based on the URL and transmit the fetched content to the printing station 30 to print the content. The structure of the embodiment transmits specification of the printing station 30 to be used for printing, as well as the print job.

The instruction client 40 gives an output instruction of each print job managed by the print portal 100. In this embodiment, the instruction client 40 is a cell phone having the functions of access to the Internet. This is, however, not restrictive at all, and the instruction client 40 may be any of personal computers, personal digital assistants, and other terminals.

The functional blocks of the print portal 100 are also shown in FIG. 1. The respective functional blocks are attained as software component in the print portal 100, although these functional blocks may alternatively be actualized as hardware circuit.

A control module 101 controls the operations of the other functional blocks included in the print portal 100 and transmission of information to and from the outside via the Internet. More specifically, the control module 101 controls registration and management of users, output instructions of print jobs, and retrieval of printers as output destinations. The control module 101 also provides interface windows to allow for communication of the print portal 100 with the outside.

A registration management module 102 takes charge of registration and management of the users, the content providers 20, and the printing stations 30, which utilize the print portal 100. The registration management module 102 accordingly has functions of creating interface windows for registration and management and storing and modifying registration-related data in a preset database.

A queuing system 106 relays the operations of the other functional blocks included in the print portal 100. In the structure of this embodiment, the respective functional blocks are constructed by the object-oriented software. Each functional block refers to a message registered in the queuing system 106, detects the presence of a print job as its processing object, and executes processing of the detected print job. On completion of the processing, the functional block registers a message representing end-of-processing in the queuing system 106. Each functional block executes the processing by relay of the queuing system 106. The print portal 100 accordingly implements a series of processing from reception of a print job to output of the processed print job. The queuing system 106 includes multiple queues required for the processing, for example, a print job registration queue, a content fetch queue, a file conversion queue, and a print job transmission queue.

A job management module 107 mainly has two functions. When a content as a print object is specified by a URL or its equivalency, the first function gains access to the content provider 20 to fetch the content specified as a print object by the user. The job management module 107 refers to the content fetch queue included in the queuing system 106 and carries out the above series of operations according to a message accumulated in the content fetch queue.

The second function of the job management module 107 manages each print job until an output instruction is given. The print portal 100 does not immediately transmit a received print job to the printing station 30, but manages the received print job until an output instruction is given. The job management module 107 acquires the print job registration queue, which is created in response to reception of the print job by the control module 101, from the queuing system 106 and manages print jobs.

The job management module 107 also functions to display a list of print jobs under management, in addition to the function of registering the print jobs. In response to an output instruction, the job management module 107 creates a file conversion queue, which is used to carry out pre-processing prior to output of a print job specified by the output instruction to the printing station 30, and registers the file conversion queue in the queuing system 106.

An authentication module 103 authenticates the user who gives the output instruction as an authorized right holder of the print job. The structure of this embodiment uses the user's voice print, one of biometric authentication techniques, for the purpose of authentication. The print portal 100 has a user database (not shown), in which information on biometric authentication of each user, for example, the user's voice print or fingerprint, and information intrinsic to the user, for example, the authority to use the printing station 30 and the authority to gain access to the content provider 20, are mapped to the user ID and are registered. The authentication module 103 refers to the user data base and authenticates the user as the authorized right holder, based on a voice print file input from the instruction client 40.

A file conversion module 104 functions to convert the respective contents into files in a PDF (registered trademark) format. Since the PDF is a general purpose format, conversion in such a general purpose format for mediation of print data advantageously facilitates output of print data to a diversity of printers. Another advantage of the PDF format is to keep the original layout of a print in a relatively faithful manner. The PDF format allows for conversion from substantially any print data including documents and images and desirably sets a wide range of contents as print objects. A page description language, such as PostScript (registered trademark) may alternatively be used as the general purpose format.

The file conversion module 104 carries out file conversion according to a message accumulated in the file conversion queue included in the queuing system 106. On completion of file conversion, a transmission message of the print job is registered in the print job transmission queue included in the queuing system 106. The file conversion module 104 is incorporated in the print portal 100 in the structure of this embodiment, but may be constructed as an external function provided by a separate server.

The procedure of this embodiment carries out file conversion of a print job after receiving an output instruction of the print job. One modified procedure may carry out file conversion of a print job immediately after receiving the print job and register the file-converted print job into the job management module 107. Another modified procedure may not depend upon reception of a print job or an output instruction but successively carry out file conversion of print jobs registered in the user database under the condition that the server has relatively light load.

A PS interface 105 functions to transmit print jobs to the printing stations 30. The PS interface 105 transmits each print job to a specified printing station 30 according to a message accumulated in the print job transmission queue included in the queuing system 106. The transmission follows a protocol set by each printing station 30, for example, HTTP (hypertext transport protocol).

A2. Output Process

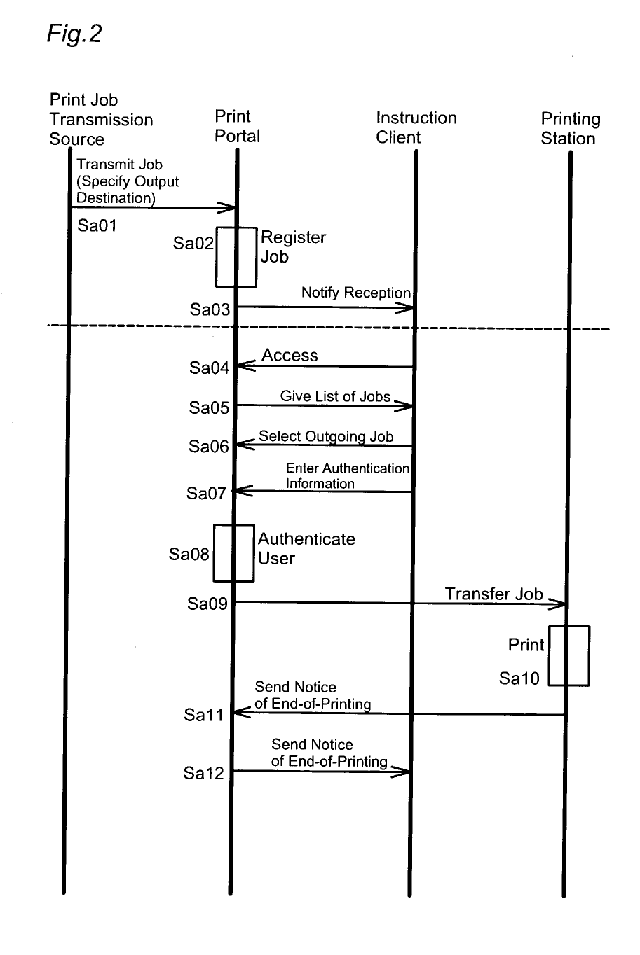

FIG. 2 is a flowchart showing an output process routine executed in this embodiment. The flowchart includes series of processing executed respectively by the print job transmission source 10, the print portal 100, the instruction client 40, and the printing station 30. The output of this embodiment is mainly divided into two phases, a transmission phase and an output phase of each print job. In the flowchart, a section above the broken line corresponds to the transmission phase of each print job, while a section below the broken line corresponds to the output phase of the print job.

In the transmission phase, the print job transmission source 10 transmits a print job to the print portal 100 (step Sa01). The print job includes specification of the output destination of the print job.

The print portal 100 registers the received print job into the job management module 107 (step Sa02), and notifies a receiver of a resulting print, that is, the user of the instruction client 40, of the reception of the print job (step Sa03). In the structure of this embodiment, e-mails are used for such notification. The e-mail address of the receiver is registered in the user database. The notification by e-mail advantageously enables the receiver to grasp the fact of reception of the print job without delay. The e-mail is not restrictive at all, and a variety of other means, for example, facsimile, are applicable for notification of the reception (step Sa03). Notification of the reception may be omitted, when not required.

In the output phase, the receiver operates the instruction client 40 to gain access to a Web page provided by the print portal 100 (step Sa04). In this process, the receiver transmits the user ID to the print portal 100.

The print portal 100 gives a list of print jobs mapped to the user ID under management to the instruction client 40 (step Sa05). The receiver selects a desired print job to be printed in the list displayed on the instruction client 40 (hereafter referred to as transferred job) (step Sa06). The receiver may alternatively have access to the print portal 100 from a client or a computer of a certain printing station 30. In this case, it is preferable that the print portal 100 gives a list of print jobs addressed to the printing station 30.

In response to a request for input of authentication information from the print portal 100, the receiver enters a voice print file as the authentication information (step Sa07). The print portal 100 authenticates the receiver as an authorized right holder, based on the input authentication information (step Sa08). In the case of successful authentication, the print portal 100 transfers the selected print job to the specified printing station 30 (step Sa09). The procedure may ask the receiver requirement or non-requirement of actual transfer of the selected print job for the purpose of confirmation. The procedure may otherwise omit such confirmation and immediately transfer the selected print job.

The printing station 30 receives the print job from the print portal 100 and executes printing of the received print job (step Sa10). On completion of printing, the printing station 30 sends a notice of end-of-printing to the print portal (step Sa11). The print portal 100 accordingly sends a notice of end-of-printing to the instruction client 40 (step Sa12). This concludes printing of the selected print job. The processing of steps Sa11 and Sa12 may be omitted, when not required.

The procedure of this embodiment sends the notice of end-of-printing to the instruction client 40. The receiver of the resulting print, who is away from the printing station 30, is thus accurately notified of the end-of-printing. The procedure may also send a notice of end-of-printing to the print job transmission source 10. The notice of end-of-printing is not restricted to a notice of successful printing, but may be a notice of failed printing that includes the number of printed pages and a request for reprinting.

A3. Internal Structure of Printing Station

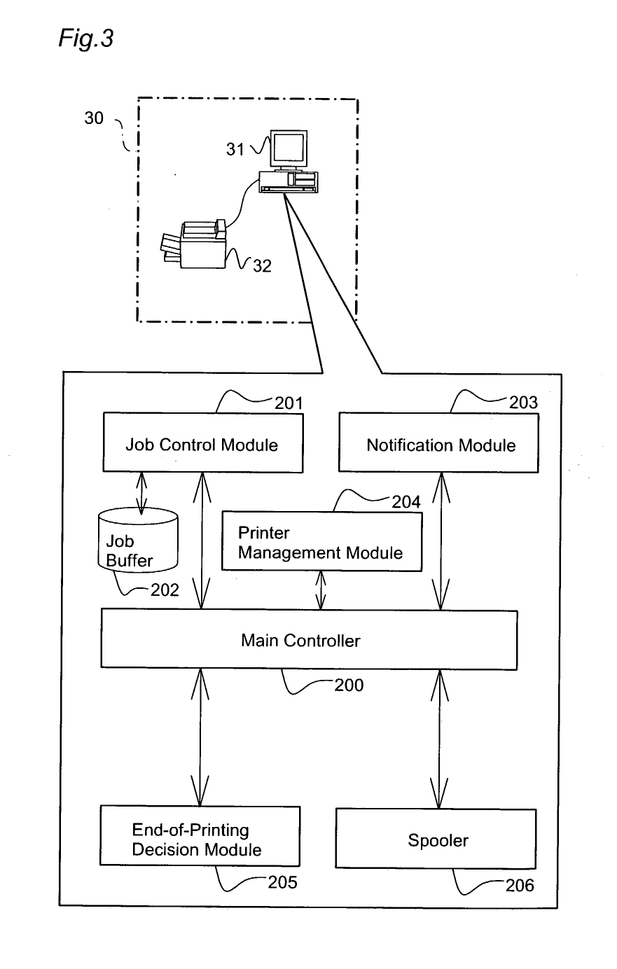

FIG. 3 schematically illustrates the internal structure of the printing station 30 in this embodiment. The printing station 30 includes a client 31 connecting with the network and a printer 32 locally connected to the client 30. The client 31 is constructed as a monitor system that monitors end-of-printing with the printer 32, and is thus hereafter referred to as the monitor system 31. As shown in FIG. 3, the monitor system 31 has multiple functional blocks, which are attained by the software component in this embodiment. These functional blocks may alternatively be actualized by the hardware circuit.

A main controller 200 controls the operations of the other functional blocks included in the monitor system 31. More specifically, the main controller 200 controls transmission of information to and from the outside via the network, acquisition of each print job, and the operating state of the printer 32 connected with the client 31.

The main controller 200 specifies a desired print job, which is to be printed currently, in a list of print jobs provided by the print portal 100 and acquires the specified print job. The print jobs are accumulated in a job buffer 202 in the order of transfer.

A job control module 201 monitors the state of the job buffer 202 at preset time intervals and, in response to detection of any print job accumulated in the job buffer 202, transmits the first accumulated print job to a spooler 206 via the main controller 200. The spooler 206 successively transfers the received print jobs to the printer 32.

A print management module 204 manages information regarding the printer 32, which is connected to the monitor system 31. In the structure of this embodiment, the information regarding the printer 32 includes the type and the status of the printer 32. The information regarding the printer 32 may additionally include other pieces of information, such as the printable paper size.

The spooler 206 starts transfer of a print job to the printer 32, while transmitting a notice of start-of-printing to an end-of-printing decision module 205 via the main controller 200. The end-of-printing decision module 205 acquires the status of the printer 32 from the printer management module 204 in response to reception of the notice of start-of-printing, and determines whether or not there is any remaining data of the print job in the spooler 206. The end-of-printing decision module 205 determines the end-of-printing of the print job, based on the acquired status of the printer 32 and the presence or the absence of any remaining data of the print job in the spooler 206. The end-of-printing decision module 205 then transmits the notice of end-of-printing to the print portal 100 via a notification module 203.

In the structure of this embodiment, the main controller 200 receives the list of print jobs from the print portal 100 and acquires the user's desired print job specified in the list. One modified procedure may sequentially execute printing of a print job every time the instruction client 40 gives a printing instruction of the print job. This is actualized by changing over the setting mode of the monitor system 31 between ‘Manually Acquire Print Jobs’ and ‘Automatically Acquire Print Jobs’.

In the structure of this embodiment, only one printer 32 is connected to the monitor system 31. Multiple printers may, however, be connected to the monitor system 31. In the latter case, the printer management module 204 manages information regarding multiple printers connected to the monitor system 31. The spooler 206 allocates a corresponding spooler area to each of the multiple printers.

For convenience of explanation, the printer 32 and the monitor system 31 are constructed as separate devices in this embodiment. The monitor system may alternatively be incorporated in the printer 32. In this structure, the printer 32 has a control unit constructed as a microcomputer including a CPU, a ROM, and a RAM.

A4. End-of-Printing Monitor Process

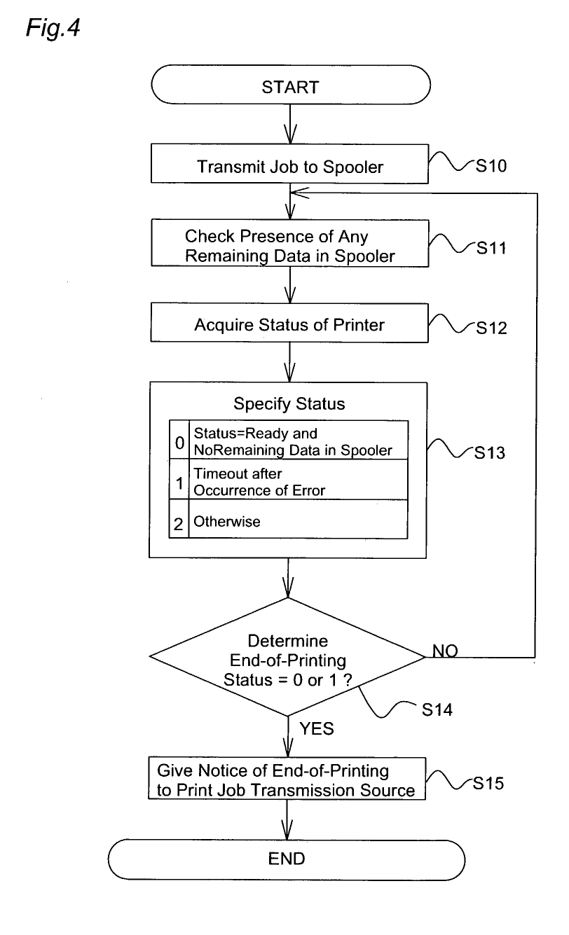

FIG. 4 is a flowchart showing an end-of-printing monitor routine executed in the first embodiment. According to this end-of-printing monitor routine, the job control module 201 determines the end-of-printing of a print job, based on the information acquired from the printer management module 204 and the spooler 206, and notifies the print portal 100 of the end-of-printing. This routine starts when the job control module 201 transmits a print job to the spooler 206.

The job control module 201 transmits a first print job accumulated in the job buffer 202 to the spooler 206 via the main controller 200 (step S10). The spooler 206 then transfers the received print job to the printer 32 to start printing. After the start of printing, the end-of-printing decision module 205 checks the presence of any remaining print data in the spooler 206 at preset time intervals via the main controller 200 (step S11), and acquires the status of the printer 32 from the printer management module 204 (step S12).

The end-of-printing decision module 205 then specifies a printing status, based on the status of the printer 32 and the presence or the absence of any remaining print data in the spooler 206 (step S13). When there is no remaining print data in the spooler 206 and the printer 32 is set in a ‘ready’ status (standby for printing), the printing status specified at step S13 is equal to ‘0’. When some error like out-of-paper arises in the printer 32 and the printer 32 is set in an ‘error’ status to a timeout, the printing status specified at step S13 is equal to ‘1’. When no error arises and there is any remaining print data in the spooler 206, or when the printer 32 is set in a ‘busy’ status (in use), the printing status specified at step S13 is equal to ‘2’.

The end-of-printing decision module 205 determines the end-of-printing according to the specified printing status. When the specified printing status is equal to either ‘0’ or ‘1’, it is determined that printing has been terminated, regardless of normal termination or abnormal termination (step S14). The end-of-printing decision module 205 then sends a notice of end-of-printing to the print portal 100 (step S15). When the specified printing status is equal to ‘2’, on the other hand, it is determined that printing has not yet been terminated. The program then returns to step S11 to repeat the above series of processing.

When the above series of processing is terminated with the printing status ‘0’, the job control module 201 transmits a next print job accumulated in the job buffer 202 to the spooler 206.

The notice of end-of-printing sent to the print portal 100 at step S15 may be a notice of successful printing or a notice of failed printing. In the case of the printing status ‘0’, the notice of successful printing is sent to the print portal 100. In the case of the printing status ‘1’, the notice of failed printing is sent to the print portal 100. The failed printing represents a failed status of printing due to various errors, for example, out-of-paper or out-of-toner.

As described above, the printing system of the first embodiment accurately determines the end-of-printing of each print job and gives a notice of end-of-printing to the print job transmission source.

In the procedure of this embodiment, the notice of end-of printing sent to the print portal 100 at step S15 may be omitted, but such notification enables the print portal 100 to issue a notice of end-of-printing to the instruction client 40, as well as to the print job transmission source 10. The user who gives a printing instruction at a place remote from the printing station 30 can thus quickly obtain the printing result. This arrangement also enables the print job transmission source 10 to assure the successful printing of its output print job, thus enhancing the convenience.

B. Second Embodiment

B1. End-of-Printing Monitor Process

The procedure of the first embodiment determines the end-of-printing by the unit of a print job. The procedure of a second embodiment, on the other hand, determines the end-of-printing by the unit of a page. The print portal 100, the monitor system 31, and the printer 32 of the second embodiment are identical with those of the first embodiment. In the structure of the second embodiment, however, the job control module 201 transmits a PDF file accumulated in the job buffer 202 to the spooler 206 by the unit of a page.

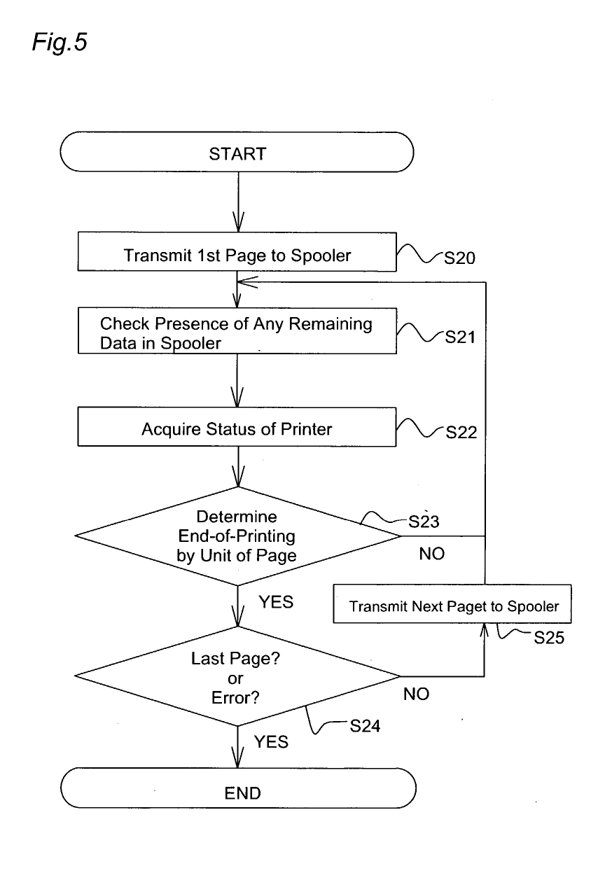

FIG. 5 is a flowchart showing an end-of-printing monitor routine executed in the second embodiment. This routine starts, when the job control module 201 transmits a print job accumulated in the job buffer 202 to the spooler 206 by the unit of a page.

The job management module 201 opens the PDF file of a head print job accumulated in the job buffer 202 and transmits a first page to the spooler 206 (step S20). The processing of steps S21 through S23 is identical with the processing of step S11 through S14 of the first embodiment, and is thus not specifically described here.

The end-of-printing decision module 205 determines whether or not the page determined as the end-of-printing at step S23 is the last page and whether or not the end-of-printing is caused by some error (step S24). When the determination result represents either the last page or the end-of-printing caused by an error, the program exits from this routine. When the determination results represents neither the last page nor an error, on the other hand, the job control module 201 transmits a next page to the spooler 206 (step S25).

The procedure of the second embodiment enables the user to accurately grasp the progress of each print job by the unit of a page and readily find the page on which an error arises.

A step of sending a notice of end-of-printing to the print job transmission module 10 is omitted in the procedure of this embodiment. This step may be added after step S24 according to the requirements. This arrangement enables the user who gives a printing instruction at a remote place from the printing station 30 to quickly obtain the detailed printing result by the unit of a page.

C. Third Embodiment

C1. Re-Printing Process

The procedures of both the first embodiment and the second embodiment terminate the end-of-printing monitor routine without any specific processing in the case of the occurrence of an error. The procedure of a third embodiment re-prints a failed page, in the case of the occurrence of an error in the course of printing. The print portal 100, the monitor system 31, and the printer 32 of the third embodiment are identical with those of the second embodiment.

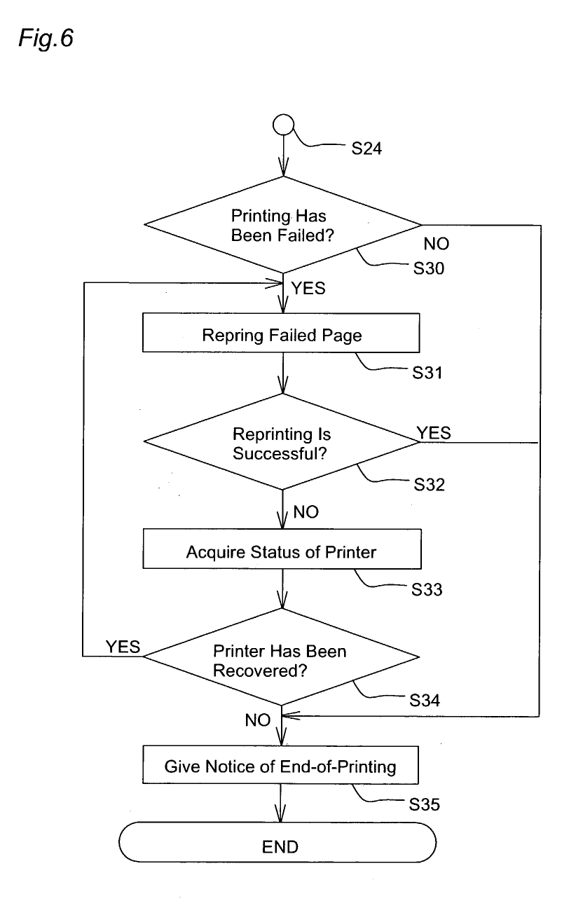

FIG. 6 is a flowchart showing a re-printing routine executed in the third embodiment. This routine is activated, in the case of an affirmative answer at step S24 of the second embodiment in the flowchart of FIG. 5. The main controller 200 controls the other functional blocks to implement this series of processing.

When the program enters this routine, the main controller 200 determines whether or not printing has been failed (step S30). In the case of successful printing, the main controller 200 actuates the notification module 203 to give a notice of end-of-printing by the unit of a page to the print portal 100 and thereby to the print job transmission source 10 (step S35). In the case of failed printing, on the other hand, the main controller 200 gives a re-printing instruction of a failed page (step S31). The main controller 200 subsequently determines whether or not reprinting is successful (step S32). In the case of successful reprinting, the main controller 200 gives the notice of end-of-printing to the print portal 100 via the notification module 203 (step S35). In the case of failed reprinting, on the contrary, the main controller 200 acquires the status of the printer 32 from the printer management module 204 (step S33), in order to check the recovery of the error arising in the printer 32. The determination of successful reprinting or failed reprinting follows the processing of steps S20 through S24 in the flowchart of the second embodiment.

The main controller 200 determines whether or not the printer 32 has been recovered, based on the acquired status of the printer 32 (step S34). When the acquired status represents ‘ready’ or ‘standby for printing’, it is determined that the printer 32 has been recovered. The program then goes back to step S31 to perform reprinting. When the acquired status represents ‘error’, it is determined that the printer 32 has not yet been recovered and is still in an unprintable state due to the error. The main controller 200 accordingly gives a notice of end-of-printing to the print portal 100 via the notification module 203 (step S35).

As discussed above, the printing system of the third embodiment resumes printing of only a failed page or a failed page and subsequent pages. This arrangement carries out reprinting without the user's reprinting instruction, thus enhancing the convenience.

The procedure of the third embodiment carries out reprinting of a failed page at step S31 only once, in the case of failed printing. Such reprinting may otherwise be carried out by a preset number of times. In this case, the program repeats the processing of steps S31 and S32 or the processing of steps S31 through S34.

Like the second embodiment, the notice of end-of-printing sent to the print portal 100 at step S35 may be omitted. The notification of the end-of-printing to the print job transmission module, however, desirably enables the user to quickly grasp the printing result.

D. Fourth Embodiment

D1. Re-Printing Process

The procedure of the third embodiment carries out reprinting immediately after a failure of printing without the user's reprinting instruction. The procedure of a fourth embodiment asks the user to select requirement or non-requirement of reprinting. The print portal 100, the monitor system 31, and the printer 32 of the fourth embodiment are identical with those of the second embodiment.

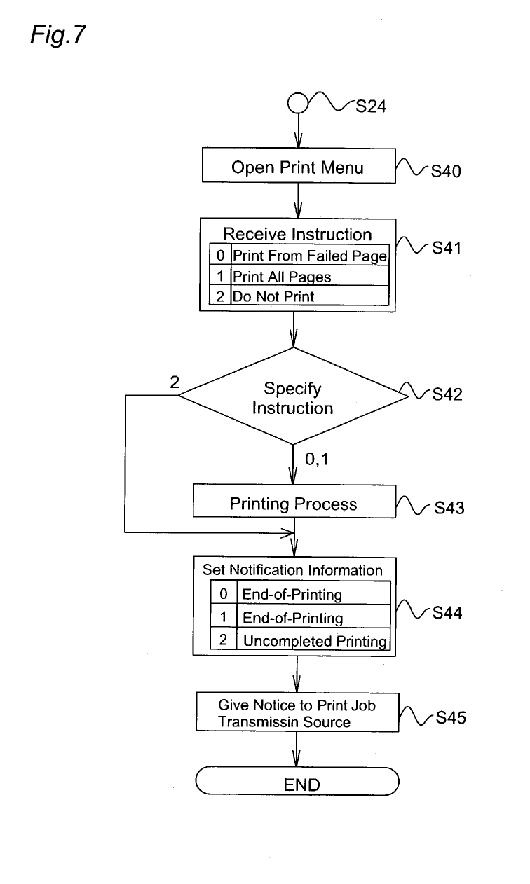

FIG. 7 is a flowchart showing a reprinting routine executed in the fourth embodiment. In the case of the occurrence of an error at step S24 in the flowchart of FIG. 5, the main controller 200 controls the other functional blocks to implement this series of processing.

When the program enters this routine, the main controller 200 opens a print menu on the display of the device manipulated by the user (step S40). The main controller 200 subsequently receives a printing instruction selected by the user in the print menu (step S41). The print menu has options ‘print from failed page’, ‘print all pages’, and ‘do not print’ for the selected printing instruction. The values ‘0’, ‘1’, and ‘2’ are respectively allocated to the options ‘print from failed page’, ‘print all pages’, and ‘do not print’.

The main controller 200 determines requirement or non-requirement of reprinting, based on the input printing instruction (step S42). In response to the input printing instruction ‘0’, the main controller 200 carries out reprinting of the failed print job from a failed page. In response to the input printing instruction ‘1’, the main controller 200 carries out reprinting of the failed print job from its first page (step S43). In response to the input printing instruction ‘2’, on the other hand, the failed print job is not subject to reprinting and the program skips the processing of step S43.

The main controller 200 then sets notification information regarding end-of-printing (step S44). In the case of either the printing instruction ‘0’ or the printing instruction ‘1’, the setting is ‘end-of-printing’. In the case of the printing instruction ‘2’, on the other hand, the setting is ‘uncompleted printing’ (step S44). The main controller 200 then gives a notice of end-of-printing or a notice of uncompleted printing to the print portal 100 and thereby to the print job transmission source 100 via the notification module (step S45).

As described above, the procedure of the fourth embodiment enables the user to arbitrarily select requirement or non-requirement of reprinting and the start page of reprinting, in the case of failed printing, thus ensuring the enhanced convenience. According to the notification information set at step S44, the print job transmission source 10 may delete the completed print job while giving a high priority to the failed print job.

When the printing instruction ‘2’ is input at step S41, the procedure of the fourth embodiment gives the notice of uncompleted printing to the print job transmission source 10 at step S45. Such notification may be omitted. In this case, only when receiving the notice of end-of-printing from the monitor system 31, the print job transmission source 10 may delete the print job.

The processing routine of the fourth embodiment is activated immediately after determination of the occurrence of an error at step S24 in the flowchart of FIG. 5. One modified procedure may open a print menu with regard to failed print jobs, when there is any failed print job in the previous cycle of the printing process. This arrangement effectively notifies the user of the presence of any failed print job, which requires reprinting, even when the previous cycle of the printing process is terminated without informing the user of the presence of any uncompleted print job.

D2. Reprinting Guide Window

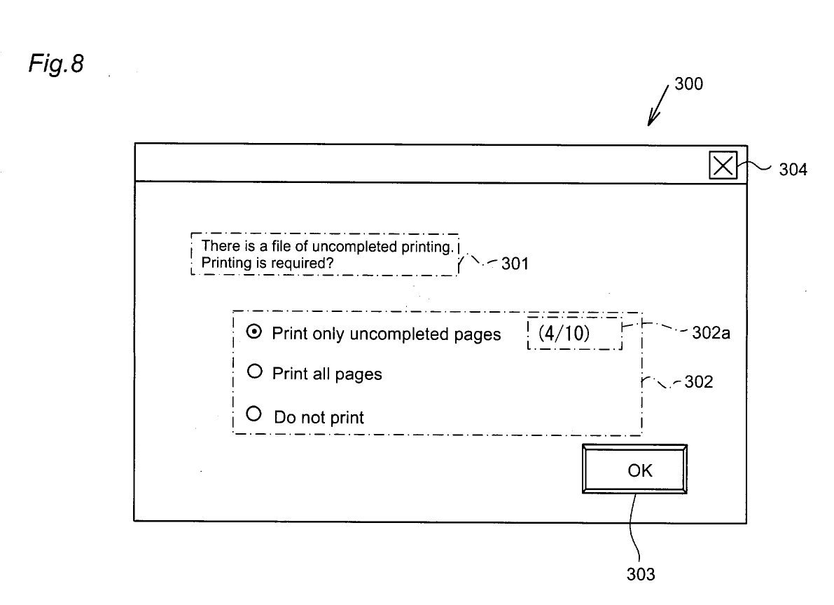

The procedure of the fourth embodiment opens the print menu at step S40 in the flowchart of FIG. 7 for guidance of reprinting. FIG. 8 shows an example of the print menu opened as a reprinting guide window in the fourth embodiment. In this illustrated example, a print menu 300 includes a description display field 301, a processing selection field 302 with an uncompleted page display section 302a, an OK button 303, and a close button 304. A message of asking the user requirement or non-requirement of reprinting is shown in the description display field 301. The uncompleted page display section 302a gives a display like ‘first failed page/total number of pages’. The processing selection field 302 shows options of processing, among which the user selects a desired one. The OK button 303 is clicked to start the processing selected in the processing selection field 302. The close button 304 is clicked to cancel the selection of the reprinting process.

In the structure of this embodiment, the description display field 301 and the processing selection field 302 have sentence messages. The reprinting guide window may otherwise give a visual guidance with still images or moving pictures, an audio guidance with voice messages, or any combination thereof.

As described above, the printing system of the fourth embodiment desirably ensures printing of a required print job. Even when the user does not receive the notice of failed printing because of any reason, this arrangement ensures reprinting of the print job from a failed page or reprinting of the whole print job.

The above embodiments are to be considered in all aspects as illustrative and not restrictive. There may be many modifications, changes, and alterations without departing from the scope or spirit of the main characteristics of the present invention. For example, the control processes described above may be actualized by the hardware circuit, instead of the software component.

The job buffer 202 may be omitted from the monitor system 31. The monitor system 31 of this modified structure may receive a next print job from the print portal 100 every time one print job is completed.

E. Modifications

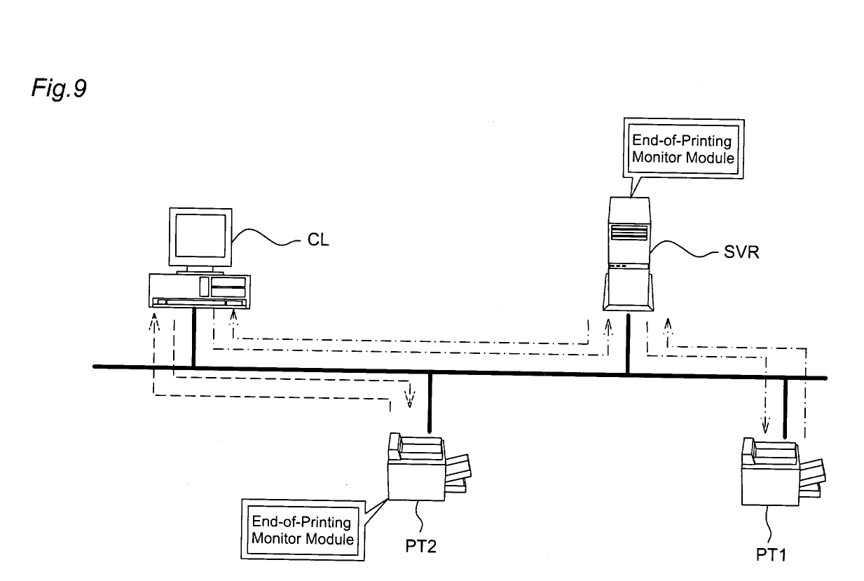

FIG. 9 schematically illustrates an end-of-printing monitor system in one modified example. In this end-of-printing monitor system, printers PT1 and PT2, a client CL, and a server SVR are connected to a network. The printer PT2 and the server SVR respectively have an end-of-printing monitor module incorporated therein.

The one-dot chain lines in FIG. 9 show the flow of a print job. The client CL outputs a print job to the server SVR, and the server SVR then transfers the print job to the printer PT1 to implement actual printing. The server SVR has functions of a printer server. The end-of-printing monitor module incorporated in the server SVR monitors the presence of any remaining data in a spooler and the status of the printer PT1. When the status of the printer PT1 is ‘ready’ or ‘standby for printing’ and when no remaining data is present in the spooler, the end-of-printing monitor module determines end-of-printing and sends a notice of end-of-printing to the client CL, which is the print job transmission source. The client CL may successively output multiple print jobs to the server SVR to make the output print jobs accumulated in a built-in job buffer of the server SVR. The client CL may alternatively output a next print job to the server SVR after reception of a notice of end-of-printing with regard to one print job.

The broken lines in FIG. 9 also show the flow of the print job. In response to reception of a printing requirement from the client CL, the end-of-printing monitor module incorporated in the printer PT2 confirms that the status of the printer PT2 is ‘ready’ or ‘standby for printing’ and transmits only one print job to its spooler to start printing of the print job. The end-of-printing monitor module monitors the presence of any remaining data in the spooler of the printer PR2 and the status of the printer PT2. When the status of the printer PT2 is ‘ready’ or ‘standby for printing’ and when no remaining data is present in the spooler, the end-of-printing monitor module determines end-of-printing and sends a notice of end-of-printing to the client CL. The client CL may output a next printing requirement after reception of the notice of end-of-printing.

The scope and spirit of the present invention are indicated by the appended claims, rather than by the foregoing description.

What is claimed is:

1. A monitor apparatus that monitors a printing apparatus, said monitor apparatus comprising:
a status acquisition module that acquires an operating state of said printing apparatus;
a data check module that checks presence or absence of any print data in a spooler corresponding to said printing apparatus;
a job control module that outputs print data to said spooler; and
a decision module that determines end-of-printing of the output print data, based on information regarding the operating state of said printing apparatus acquired by said status acquisition module and regarding the presence or the absence of any print data in said spooler checked by said data check module.

2. A monitor apparatus in accordance with claim 1, wherein said decision module determines end-of-printing, when there is no print data in said spooler and the operating state of said printing apparatus acquired by said status acquisition module represents standby for printing.

3. A monitor apparatus in accordance with claim 1, wherein said job control module forbids output of next print data until said decision module determines end-of-printing of currently output print data.

4. A monitor apparatus in accordance with claim 1, wherein the print data has a predetermined format that allows for output by the unit of a page,
said job control module outputs the print data by the unit of a page, and
said decision module determines a printing result of the print data by the unit of a page.

5. A monitor apparatus in accordance with claim 1, said monitor apparatus and said printing apparatus, as well as a job output apparatus that outputs a print job to said printing apparatus, being connected with a network,
said monitor apparatus further comprising:
a result notification module that notifies said job output apparatus of a decision result regarding end-of-printing of the output print job at a preset timing.

6. A monitor method that monitors a printing apparatus, said monitor method comprising the steps of:
(a) acquiring an operating state of said printing apparatus;
(b) checking presence or absence of any print data in a spooler corresponding to said printing apparatus;
(c) outputting print data to said spooler; and
(d) determining end-of-printing of the output print data, based on information regarding the operating state of said printing apparatus acquired in said step (a) and regarding the presence or the absence of any print data in said spooler checked in said step (b).

7. A monitor method in accordance with claim 6, in the step (d), determining end-of-printing, when there is no print data in said spooler and the operating state of said printing apparatus represents standby for printing.

8. A monitor method in accordance with claim 6, in the step (c), forbidding output of next print data until determining end-of-printing of currently output print data.

9. A monitor method in accordance with claim 6, wherein the print data has a predetermined format that allows for output by the unit of a page,
outputting the print data by the unit of a page in the step (c), and
determining a printing result of the print data by the unit of a page in the step (d).

10. A monitor method in accordance with claim 6 executed by a monitor apparatus, said monitor apparatus and said printing apparatus, as well as a job output apparatus that outputs a print job to said printing apparatus, being connected with a network,
said monitor method further comprising a step of notifying said job output apparatus of a decision result regarding end-of-printing of the output print job at a preset timing.

11. A computer readable recording medium in which a computer program that is activated to monitor and control a printing apparatus is recorded, said computer program causing a computer to attain the functions of:
acquiring an operating state of said printing apparatus;
checking presence or absence of any print data in a spooler corresponding to said printing apparatus;
outputting print data to said spooler; and
determining end-of-printing of the output print data, based on information regarding the acquired operating state of said printing apparatus and regarding the checked presence or absence of any print data in said spooler.

12. A computer readable recording medium in accordance with claim 11, determining end-of-printing, when there is no print data in said spooler and the operating state of said printing apparatus represents standby for printing.

13. A computer readable recording medium in accordance with claim 11, forbidding output of next print data until determining end-of-printing of currently output print data.

14. A computer readable recording medium in accordance with claim 11, wherein the print data has a predetermined format that allows for output by the unit of a page,
the program outputting the print data by the unit of a page, and
the program determining a printing result of the print data by the unit of a page.

15. A computer readable recording medium in accordance with claim 11 executed by a monitor apparatus, said monitor apparatus and said printing apparatus, as well as a job output apparatus that outputs a print job to said printing apparatus, being connected with a network,
said program further notifying said job output apparatus of a decision result regarding end-of-printing of the output print job at a preset timing.
